(19) United States
(12) Patent Application Publication
(10) Pub. No.: US 2014/0216850 A1
(43) Pub. Date: Aug. 7, 2014

(54) Mount System

(71) Applicant: Martin Joseph Markley, Lenexa, KS (US)

(72) Inventor: Martin Joseph Markley, Lenexa, KS (US)

(21) Appl. No.: 14/171,363

(22) Filed: Feb. 3, 2014

Related U.S. Application Data
(60) Provisional application No. 61/849,980, filed on Feb. 6, 2013.

(51) Int. Cl. E06C 7/46

(52) U.S. Cl. CPC E06C 7/46
USPC 182/109; 182/111

(57) ABSTRACT

A mount system includes two different friction enhancing surfaces that attach to at least one leg of a support structure and form a stable surface area for inhibiting movement by the leg. A mount joins with a terminal end of the leg. The mount includes a first surface having at least one protrusion configured to penetrate the ground surface. The mount also includes a second surface having a frictional surface. The surfaces are reversible, whereby either the first or second surface engages the ground surface depending on the type of ground surface. The mount has a larger surface area than the terminal end to provide additional frictional forces for inhibiting movement of the support structure. A bracket overlays the mount and engages the terminal end. A fastener, such as a quarter turn cam lock enables efficient and fast removal of the bracket for reversing the surfaces.

### CROSS-REFERENCE TO RELATED APPLICATIONS

The present Utility patent application claims priority benefit of the [U.S. provisional application for patent Ser. No. 61/849,980 titled “Method and Apparatus to enable a person to increase the surface area of a ladder shoe,” filed on 6 Feb. 2013 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a mount system. More particularly, the invention relates to a reversible mount system that provides a stable mounting surface for a support structure.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a ladder is a vertical or inclined set of rungs or steps. A rigid ladder can be leaned against a vertical surface such as a wall and supported by legs.

Typically, the legs on a ladder support any weight or movement on the opposite end of the ladder. The legs include terminal ends, such as ladder shoes, that may pivot to create additional angles for positioning. The terminal ends engage different types of ground surfaces.

It is well known that friction is the force resisting the relative motion of solid surfaces, fluid layers, and material elements sliding against each other. Dry friction resists relative lateral motion of two solid surfaces in contact. The greater the friction between the terminal end of the ladder, the less movement results on the support structure.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary support structure resting on an exemplary pair of reversible mount systems, in accordance with an embodiment of the present invention; and

FIG. 2 illustrates a blow up view of an exemplary a reversible mount system that provides a stable mounting surface for a support structure with an exemplary first surface and an exemplary second surface, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of mount systems that may be provided by preferred embodiments of the present invention. In one embodiment of the present invention, the mount system may provide a mount that attaches to at least one leg of a support structure and forms a stable surface area for inhibiting movement by the at least one leg. In some embodiments, the support structure may include a ladder configured to lean on a barrier and support a load, whereby the at least one leg receives pressure and movement as a result of the load. The movement on the legs may be caused from weight on the support structure as frictional forces between the legs and a ground surface are overcome. This may lead to sliding by the legs.

In some embodiments, the mount system may inhibit such movement by providing a mount that joins with the legs and is efficacious for creating frictional forces with the ground surface. The mount may include at least two types of surfaces configured to reversibly engage different types of ground surfaces. The surfaces may include a first surface having at least one protrusion for penetrating the ground surface, and a second surface having a frictional surface for inhibiting lateral movement between the ground surface and the second surface. The surfaces may be interchanged by flipping over, and fastened into place with at least one bracket and at least one fastener. The mount may form a larger surface area than the at least one terminal end for engaging a larger area on the ground. In this manner, the mount overlays the terminal end, the area in engagement with the ground surface is greater, and thus a larger amount of frictional forces are available for inhibiting movement by the support structure. The two surfaces and the large surface area combine to provide an enhanced grip that inhibits the legs from slipping or moving.

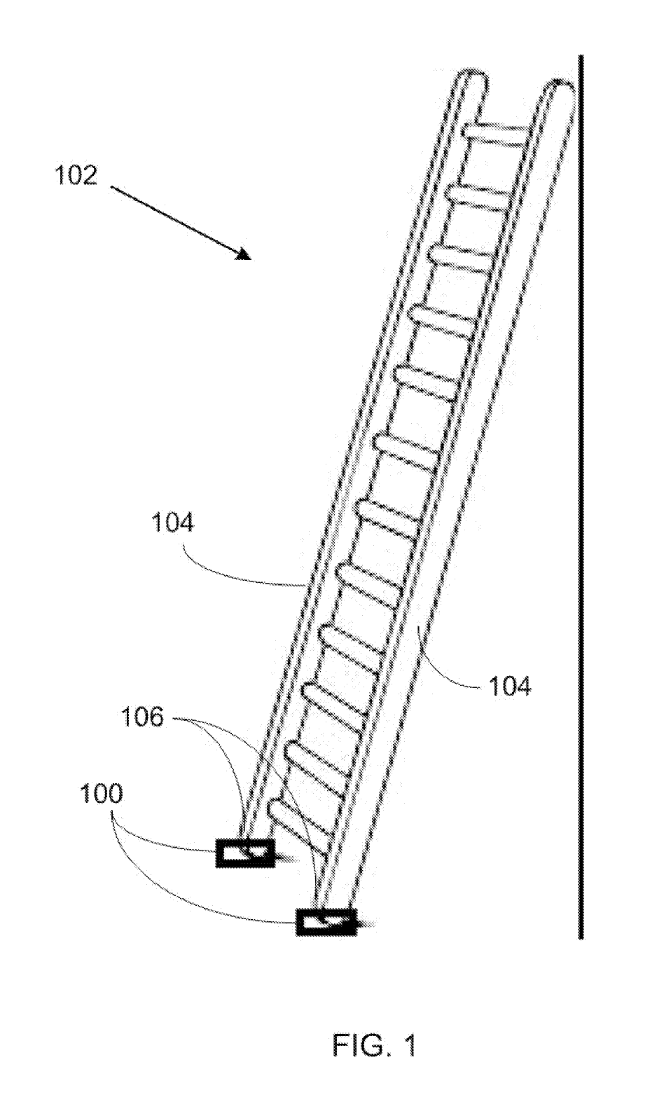

FIG. 1 illustrates a detailed perspective view of an exemplary support structure resting on an exemplary pair of reversible mount systems, in accordance with an embodiment of the present invention. In the present invention, a mount system 100 may provide a mount that joins with at least one leg 104 of a support structure 102 and forms a stable surface area for inhibiting movement by the at least one leg. The support structure may include, without limitation, a ladder, a step ladder, a climbing pole, and any vertical or inclined rung of steps that supports a load and rests on at least one leg.

In some embodiments, the support structure may include a ladder configured to lean on a barrier and support a load, whereby the at least one leg receives pressure and movement due to the load. The movement by the legs may be caused from weight on the support structure as frictional forces between the legs and a ground surface are overcome. This may lead to sliding by the legs. The mount may overlay at least one terminal end 106 on the at least one leg. The mount may securely fasten to the at least one terminal end with at least one bracket and at least one fastener. A first surface and a second surface are reversible to engage different ground surfaces.

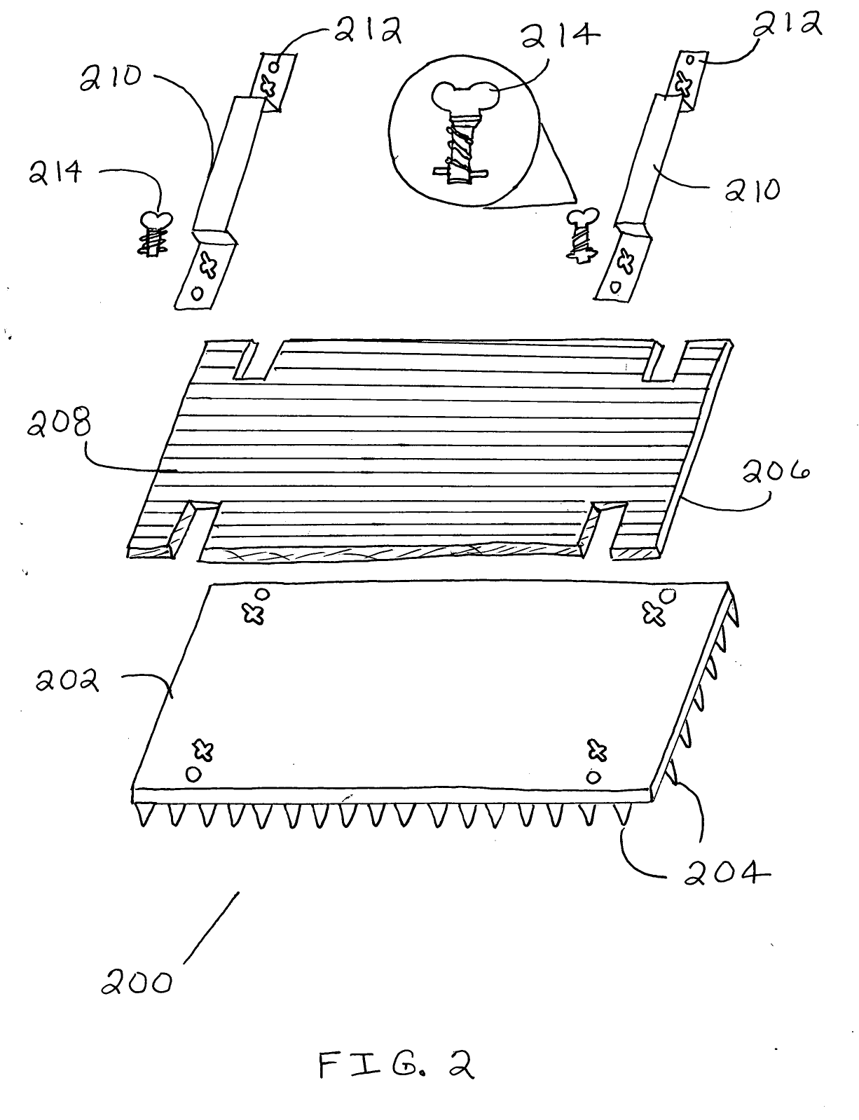

FIG. 2 illustrates a blow up view of an exemplary reversible mount system that provides a stable mounting surface for a support structure with an exemplary first surface and an exemplary second surface. In the present invention, the mount system may inhibit such movement by providing a mount 200 that joins with the legs and is efficacious for creating frictional forces with the ground surface. Suitable materials for the mount system may include, without limitation, metal, alloys, high density polyethylene, rubber, rigid polymers, and wood.

In some embodiments, the mount may include at least two types of surfaces configured to reversibly engage different types of ground surfaces. The surfaces may include a first surface 202 having at least one protrusion 204 for penetrating the ground surface. The at least one protrusion may include spikes. The at least one protrusion may comprise a molded high density polyethylene composition. In one embodiment, the first surface with the protrusions may be efficacious for engaging a grass, dirt, or mulch ground surface that can be penetrated without damage.

In some embodiments, the mount may include a second surface 206 having a frictional surface 208 for inhibiting lateral movement between the ground surface and the second surface. The frictional surface may include a soft rubber corrugated mat. The soft rubber corrugated mat may be configured to at least partially fasten to said frictional surface with an adhesive. In some embodiments, the second surface with the frictional force may be efficacious for engaging a wood or tile ground surface that creates frictional forces with the frictional surface.

The mount may form a larger surface area than the at least one terminal end for engaging a larger area on the ground. In this manner, the area in engagement with the ground surface is greater with the mount attached; and thus a larger amount of frictional forces are available for inhibiting movement by the support structure. The two surfaces and the large surface area combine to provide an enhanced grip that inhibits the legs from slipping or moving. Embodiments of the mount can be virtually any size, but not so large so as to make movement of the ladder too difficult.

The first and second surfaces may be interchanged by flipping over, and fastened into place with at least one bracket 210 and at least one fastener 214. The at least one bracket comprises at least one aperture 212 for enabling at least partial passage of the fastener. In one embodiment, the fastener may include a 1/4 turn cam lock fastener that provides an efficient and fast mechanism for removing the fastener, rotating the bracket away from the mount, flipping the mount to reverse surfaces, and refastening the bracket with the cam lock. Embodiments of this fastening mechanism include, but are not limited to, Dzus fasteners, nuts and bolts, screws or slots into which straps slide. In one embodiment, the at least one bracket may permanently attach to the terminal end, swiveling away from the terminal end to enable the mount to join, and swiveling over the mount for fastening. In this manner, the mount may be utilized on various support structures, or different mounts may be joined with the same support structure.

In one alternative embodiment, the mount system joins with any inclined structure that supports a load or experiences oscillating or agitating movement. In another alternative embodiment, the surfaces can include a ridges surface, a sucker surface, a magnetic surface, and a surface coated with an adhesive. In yet another alternative embodiment, the bracket may permanently attach to the terminal end, such that the mount can be utilized on various support structures, or different mounts may be joined with the same support structure.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a frictional mount that inhibits undesirable movement by a support structure according to the present invention will be apparent to those skilled in the art. Various aspects of the invention have been described above by way of illustration, and the specific embodiments disclosed are not intended to limit the invention to the particular forms disclosed. The particular implementation of the frictional mount that inhibits undesirable movement by a support structure may vary depending upon the particular context or application. By way of example, and not limitation, the frictional mount that inhibits undesirable movement by a support structure described in the foregoing were principally directed to a reversible mount that joins with the legs of a ladder, and includes a first surface and a second surface that reversibly engage the ground, depending on the type of ground implementations; however, similar techniques may instead be applied to chair and table legs, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a mount configured to inhibit movement by a support structure, said support structure comprising at least one leg for supporting a load, said at least one leg comprising at least one terminal end for engaging a ground surface, said mount disposed to at least partially overlay said at least one terminal end,
said mount comprising a first surface configured to engage said ground surface or said at least one terminal end, said first surface comprising at least one protrusion configured to at least partially penetrate said ground surface,
said mount further comprising a second surface configured to engage said ground surface or said at least one terminal end, said second surface comprising a frictional surface configured to inhibit lateral movement between said ground surface and said second surface,
wherein, when said first surface engages said ground surface, said second surface engages said at least one terminal end,
wherein, when said first surface engages said at least one terminal end, said second surface engages said ground surface.

2. The system of claim 1, in which said support structure comprises a ladder.

3. The system of claim 2, in which said at least one leg comprises two legs from said ladder.

4. The system of claim 3, in which said at least one terminal end comprises two ladder shoes.

5. The system of claim 4, in which said first surface is configured to engage a grass ground surface.

6. The system of claim 5, in which said second surface is configured to engage a wood ground surface.

7. The system of claim 6, in which said first surface and said second surface are configured to reversibly change positions depending on said ground surface.

8. The system of claim 7, in which said mount comprise a mount surface area greater than a terminal end surface area of said at least one terminal end.

9. The system of claim 8, in which said mount comprises a molded high density polyethylene composition.

10. The system of claim 9, in which said at least one protrusion comprises spikes configured to at least partially penetrate grass, soil, and a soft surface.

11. The system of claim 10, in which said at least one protrusion is configured to be molded into said first surface.

12. The system of claim 11, in which said frictional surface comprises a soft rubber corrugated mat.

13. The system of claim 12, in which said soft rubber corrugated mat is configured to at least partially fasten to said frictional surface with an adhesive.

14. The system of claim 13, in which said inhibited lateral movement comprises a frictional force.

15. The system of claim 14, in which said system comprises at least one bracket configured to detachably overlay said mount and engage said at least one terminal end, said at least one bracket configured to at least partially conform to said mount.

16. The system of claim 15, in which said at least one bracket comprises at least one aperture for enabling at least partial passage of said at least one fastener.

17. The system of claim 16, in which said at least one bracket comprises a metal composition.

18. The system of claim 17, in which said system comprises at least one fastener configured to at least partially fasten said bracket and said mount to said at least one terminal end, said at least one fastener comprising at least one 1/4 turn cam lock fastener.

19. A system comprising:
means for inclining a support structure against a barrier;
means for applying a load against at least one terminal end of at least one leg;
means for joining a mount with said at least one terminal end;
means for at least partially securing said mount to said at least one terminal end with at least one bracket and at least one fastener;
means for engaging a first surface with a ground surface;
means for at least partially removing said at least one bracket by manipulating said at least one fastener;
means for reversing said first surface and a second surface; and
means for engaging said second surface with said ground surface.

20. A system consisting of:
a mount configured to inhibit movement by a support structure, said support structure comprising a ladder, said support structure comprising at least one leg for supporting a load, said at least one leg comprising at least one terminal end for engaging a ground surface, said mount disposed to at least partially overlay said at least one terminal end, said mount comprising a molded high density polyethylene composition,
said mount comprising a first surface configured to engage said ground surface or said at least one terminal end, said first surface comprising at least one protrusion configured to at least partially penetrate said ground surface, said at least one protrusion comprising spikes,
said mount further comprising a second surface configured to engage said ground surface or said at least one terminal end, said second surface comprising a frictional surface configured to inhibit lateral movement between said ground surface and said second surface, said frictional surface comprising a soft rubber corrugated mat, said soft rubber corrugated mat being configured to at least partially fasten to said frictional surface with an adhesive,
wherein, when said first surface engages said ground surface, said second surface engages said at least one terminal end,
wherein, when said first surface engages said at least one terminal end, said second surface engages said ground surface;
at least one bracket configured to detachably overlay said mount and engage said at least one terminal end, said at least one bracket configured to at least partially conform to said mount; and
at least one fastener configured to at least partially fasten said bracket and said mount to said at least one terminal end, said at least one fastener comprising at least one 1/4 turn cam lock fastener.
